(19) United States
(12) Patent Application Publication
(10) Pub. No.: US 2011/0115331 A1
(43) Pub. Date: May 19, 2011

(54) CARBON BRUSH ASSEMBLY OF SLIP RING

(75) Inventors: Meng-Chiu Yu, Taichung City (TW); Su-Chen Liao, Taichung City (TW)

(73) Assignee: TAIWAN LONG HAWN ENTERPRISE CO., Taichung City (TW)

(21) Appl. No.: 12/622,104

(22) Filed: Nov. 19, 2009

(51) Int. Cl. H01R 39/40

(52) U.S. Cl. 310/246

(57) ABSTRACT

The present invention relates to a carbon brush assembly of a slip ring, wherein the slip ring further has a conductive ring. The carbon brush assembly includes a base having two tilted rails, and on each of which a carbon brush is movably mounted for reciprocation. Two biasing members are mounted on the base to urge the carbon brushes toward a conductive ring for keeping the carbon brushes in contact with the conductive ring.

### BACKGROUND OF THE INVENTION

1. Field of the Invention

The present invention relates generally to a slip ring, and more particularly, to a carbon brush assembly of a slip ring.

2. Description of the Related Art

Typically, a conventional motor includes a shaft for rotation, a plurality of conductive rings and insulating rings alternately fit to the shaft for rotation with the shaft, and a plurality of fixed carbon assemblies contacted with the conductive rings respectively. A power supply is connected to the carbon assemblies to supply power to the rotary conductive rings.

FIG. 4 shows a conventional carbon brush assembly 50 of a slip ring which has a base fixed to a bar 54, two arms 56 pivoted on opposite ends of the base 52, two carbon brushes 58 on inner sides of the arms 56, and a spring 60 having opposite ends connected to the arms 56. The spring 60 is a compression spring drawing the arms inwards to keep the carbon brushes 58 in contact with a conductive ring 62.

FIG. 4 shows the carbon brushes 58 are new. Directions of the carbon brushes 58 exerting the conductive ring 62 are perpendicular to the arms 56 and point to a center C of the conductive ring 62. After the slip ring works for a period, the carbon brushes 58 will be worn and the spring 60 will draw the arms 56 inwards to keep the worn carbon brushes 58 in contact with a conductive ring 62. We find some problems in the slip ring under such condition:

First, when the carbon brushes 58 are worn out, the directions of the carbon brushes 58 exerting the conductive ring 62 still are perpendicular to the arms 56 but deviate from the center C of the conductive ring 62. As shown in FIG. 5, the force F of one of the carbon brushes 58 exerting the conductive ring 62 may be divided into a normal force Fy and a tangential force Fx. The normal force Fy points the center C and the tangential force Fx is perpendicular to the normal force Fy. Under such condition, the carbon brushes 58 will pump when the conductive ring 62 is spinning due to a reduction of the force Fy, which will press the corresponding carbon brush 58 on the conductive ring 62, and the tangential force Fx. The pumping carbon brushes 58 will cause an unstable current and discharge. Additionally, under such condition the carbon brushes 58 are worn more at a distal end than at a proximal end that the carbon brushes 58 have to be replaced when the distal end is too thin, even when the proximal end still is thick.

### SUMMARY OF THE INVENTION

The primary objective of the present invention is to provide a carbon brush assembly of a slip ring, of which the carbon brushes can still work stably when they are worn.

The secondary objective of the present invention is to provide a carbon brush assembly of a slip ring, of which the carbon brushes are worn evenly.

According to the objective of the present invention, a carbon brush assembly of a slip ring includes a base having a rail; a carbon brush movably mounted to the rail for reciprocation along the rail, and a biasing member urging the carbon brush toward a conductive ring of the slip ring to keep the carbon brush in contact with the conductive ring.

### BRIEF DESCRIPTION OF THE DRAWINGS

FIG. 1 is an exploded view of a preferred embodiment of the present invention;

FIG. 2 is a sketch diagram of the preferred embodiment of the present invention, showing the new carbon brushes;

FIG. 3 is a sketch diagram of the preferred embodiment of the present invention, showing the worn carbon brushes;

FIG. 4 is a sketch diagram of the conventional slip ring; and

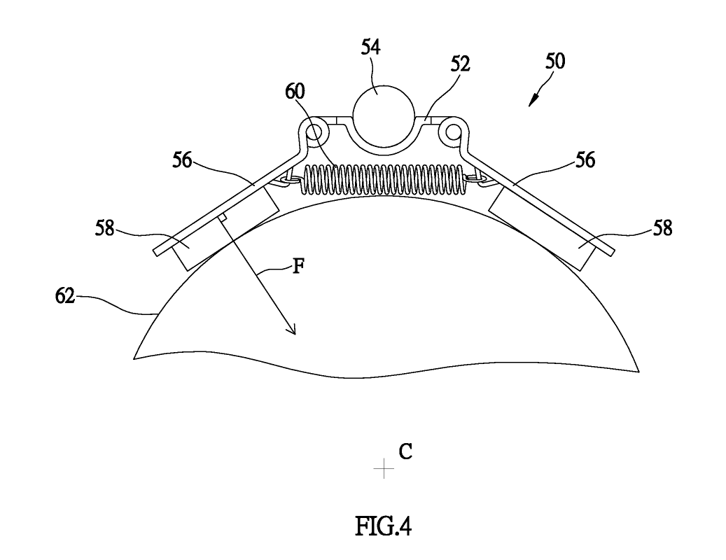

FIG. 5 is a sketch diagram of the conventional slip ring, showing the worn carbon brushes.

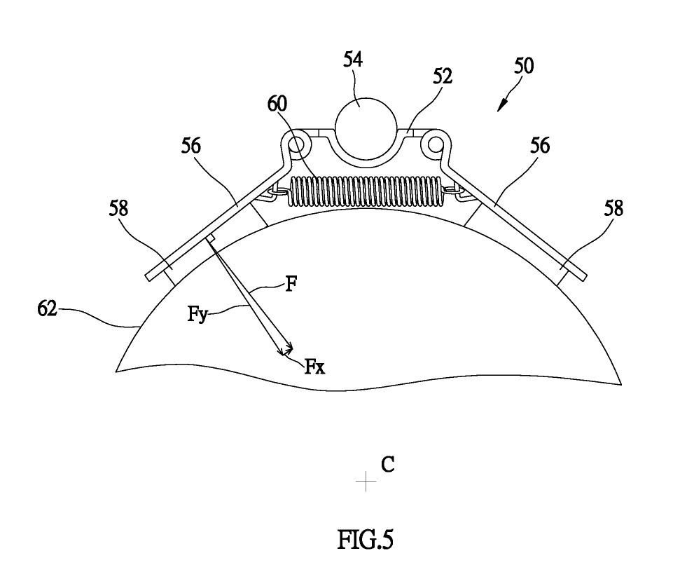

### DETAILED DESCRIPTION OF THE INVENTION

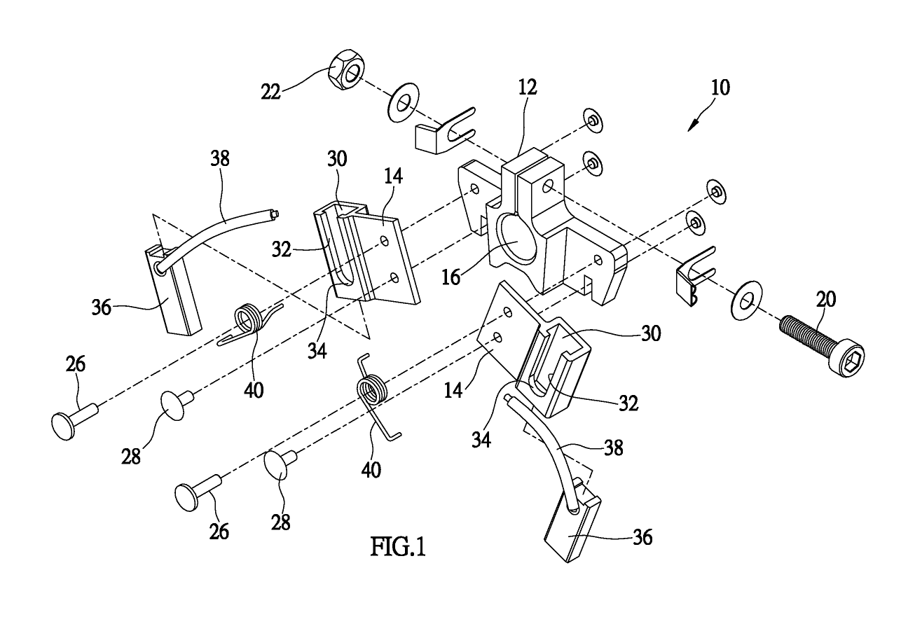

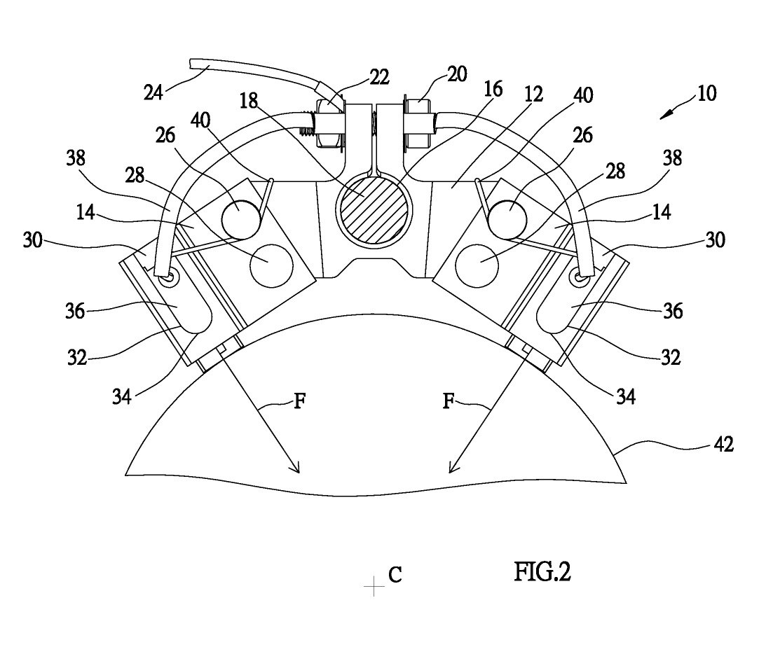

As shown in FIG. 1 and FIG. 2, a carbon brush assembly of a slip ring of the preferred embodiment of the present invention mainly includes a base 10, two carbon brushes 36 and two biasing members 40.

The base 10 has a body 12 and two frames 14. The body 12 has an opening 16 to be fitted to a bar 18 of the slip ring and secured by a bolt 20 and a nut 22 that the base 10 is fixed at a predetermined position in the slip ring. A wire 24 has an end connected to the body 12 by the bolt 20 and the nut 22 and the other end connected to an external circuit (not shown). The frames 14 are fixed to opposite sides of the body 12 by rivets 26, 28 and are tilted inwards. Each of the frames 14 has a rail 30. In the present invention, the rail 30 is a rectangular tunnel with two open ends. Each of the tunnel 30 has a slot 32 on a sidewall thereof which is open at a distal end of the sidewall and extended inward about ¾ of a length of the tunnel 30. Therefore, the tunnel 30 forms a stop portion 34 at the inner end of the slot 32.

The carbon brushes 36 are two rectangular blocks installed in the tunnel 30. At an end of each carbon brush 36 there is an opening, in which an end of a wire 38 fixed, and the other end of the wire 38 is connected to the bolt 20 that the carbon brushes 36 are electrically connected to the external circuit (not shown). The wire 38 passes through the slot 32 and works like a stop member that one of the carbon brushes 36 is stopped when the wire 38 touches the stop portion 34.

In the present invention, the biasing members 40 are two torsional springs, each of which has a loop fitted to a post of the rivet 26 and two opposite ends against the body 12 and the carbon brushes 36.

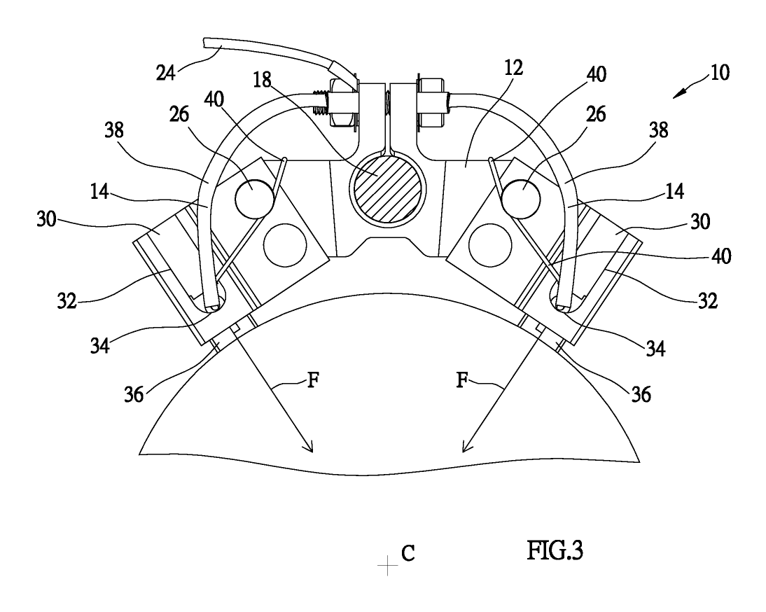

As shown in FIG. 2, the biasing members 40 urge the carbon brushes 36 toward a conductive ring 42 to keep the carbon brushes 36 in contact with the conductive ring 42. The rails 30 point to a center C of the conductive ring 42 that the carbon brushes 36 only may reciprocate along paths through the center C of the conductive ring 42. Therefore, when the slip ring works for a time and the carbon brushes 36 are worn, as shown in FIG. 3, force F of the carbon brushes 36 exerting the conductive ring 42 still points to the center C of the conductive ring 42 and no tangential force is produced that the carbon brushes 36 have less chance to pump when the slip ring is working. Additionally, the carbon brushes 36 are evenly worn to avoid the problem of material waste because of uneven wearing.

The description above is a few preferred embodiments of the present invention. Those equivalences of the present invention are still in the scope of claim construction of the present invention.

What is claimed is:

1. A carbon brush assembly of a slip ring, comprising:
a base having a rail;
a carbon brush movably mounted to the rail for reciprocation along the rail, wherein the rail has an end proximal to a conductive ring of the slip ring, and an opposite end distal to the conductive ring; and
a biasing member urging the carbon brush toward the conductive ring to keep the carbon brush in contact with the conductive ring.

2. The carbon brush assembly as defined in claim 1, wherein the rail has a tunnel, in which the carbon brush is received.

3. The carbon brush assembly as defined in claim 2, wherein the rail has a slot, which has a stop portion at an end thereof, on a sidewall of the tunnel, and the carbon brush has a stop member through the slot to stop the carbon brush when the stop member touches the stop portion.

4. The carbon brush assembly as defined in claim 3, wherein the stop member is a wire through the slot to connect the carbon brush to an external circuit.

5. The carbon brush assembly as defined in claim 3, wherein the biasing member is a torsional spring with a loop fitted to a post of the base and opposite ends against the base and the carbon brush.

6. The carbon brush assembly as defined in claim 1, wherein the base has a body and a frame, on which the rail is provided, fixed to the body and tilted for a predetermined angle.

7. The carbon brush assembly as defined in claim 6, wherein the frame is fixed to the body by a rivet, which has a post to mount the biasing member.

8. The carbon brush assembly as defined in claim 1, wherein the carbon brush is provided with a stop member, and the rail is provided with a stop portion to stop the carbon brush when the stop member touches the stop portion.

9. The carbon brush assembly as defined in claim 8, wherein the stop member is a wire connected to an external circuit.

10. The carbon brush assembly as defined in claim 1, wherein an orientation of the rail passes through a center of the conductive ring.
